(19) United States
(12) Patent Application Publication
(10) Pub. No.: US 2013/0016582 A1
(43) Pub. Date: Jan. 17, 2013

(54) SYSTEM FOR EXPLORATION OF SUBTERRANEAN STRUCTURES

(71) Applicants: Truls Fallet, Oslo (NO); Erling Woods, Hafrsfjord (NO)

(72) Inventors: Truls Fallet, Oslo (NO); Erling Woods, Hafrsfjord (NO)

(73) Assignee: BADGER EXPLORER ASA, Stavanger (NO)

(21) Appl. No.: 13/508,491

(22) PCT Filed: Nov. 9, 2010
(86) PCT No.: PCT/EP2010/067115

§ 371 Date: Sep. 27, 2012

(30) Foreign Application Priority Data
Nov. 9, 2009 (NO) 20093306

(51) Int. Cl. G01V 1/28; G01V 1/00

(52) U.S. Cl. 367/38; 367/37

(57) ABSTRACT

A system for communication through subterranean structures underneath a surface comprises at least one exploration tool adapted to penetrate into the underground, at least one transmitter, at least one receiver, and signal transfer means for transmitting signals between the exploration tool and a recording unit arranged overground, where at least one of the transmitter or receiver is integrated in the exploration tool. The exploration tool is a device which is able to penetrate into the underground in order to bring equipment into the underground independent of any existing or new wells.

The invention regards a system for exploration of structures.

There is a constant need to perform surveys of subterranean structures underneath a surface for identifying structures of interest. Examples of structures of interest in the subterranean structure include subsurface bodies of different resistivity, such as oil bearing reservoirs, gas injection zones, and fresh water aquifers.

Often it is desirable to map large areas for planning the best way to exploit oil/gas resources and also subsequent monitor the same kind of areas in order to detect/discover unexpected changes in reservoirs or watch movement of gas or water in the reservoirs.

Electrical prospecting is among the oldest techniques used, first applied by the Schlumberger brothers in the early days of last century. However, in order to get the most useful measurement, the electric probes should be positioned deep down in the reservoir sections of the underground.

Traditionally surveying subterranean structures has been performed by seismic methods, ie. air gun towed behind the survey ship transmitting sound waves through the water column and into the subsurface. Changes in rock type or fluid content provide interfaces that reflect the sound waves towards the surface, and receivers towed behind the vessel record how long it takes for the sound waves to return to the surface. The sound waves reflected by different boundaries arrive at different times and from this the location of the boundaries may be calculated/estimated.

U.S. Pat. No. 5,724,311 describes long-term seismic monitoring of an underground area by means of seismic methods. Sources buried shallowly in the ground or placed on the surface on the ground and receivers arranged in the ground or in existing wells are permanently placed in order to be able to perform reproducible seismic monitoring sessions.

In the recent years also electromagnetic prospecting methods have been developed. Electrical resistivity measurements near a borehole has also been used to determine production zones and to map sand and shale layers.

US 2004/0239329 describes a method for locating a receiver in a borehole having a conductive liner. A transmitter is located in a well and a receiver in a second well. By measuring the electromagnetic field in at least two positions in the second well, the position of the receiver may be calculated. By compensating for the effect of a conductive casing, the accuracy of the measurement may be increased.

US 2003/0209347 regards systems and methods for monitoring a characteristic of a subterranean hydrocarbon reservoir surrounding a borehole and for placing a borehole in the vicinity of a well in an earth formation. The publication describes that electrical resistivity depends on porosity, pore-fluid resistivity and saturation.

Porous formations having high resistivity generally indicate the presence of hydrocarbons, while low-resistivity formations are generally water saturated. The characteristics of the hydrocarbon reservoir is monitored by transmitting electromagnetic signals from an antennae and receive at a different antennae. A number of transmitter and receiver antennas may be used in same and different wells. The drilling of a new well can be controlled by means of electromagnetic signals transmitted between an existing well and a drill string near the well.

One problem connected to electromagnetic measurements in wells, is the conductivity of the casing of the well. Also a complete mapping of an area using such techniques depends on the wells being distributed regularly spaced in the area or distributed preferably with respect to the characteristics of the underground.

The object of the invention is to provide a method and system for exploration of structures underground in order to characterize them without the need for drilling conventional wells.

The object is achieved by means of the features of the patent claims.

In one embodiment the system for communication through subterranean structures underneath a surface comprises at least one exploration tool adapted to penetrate into the underground, at least one transmitter, at least one receiver, and signal transfer means for transmitting signals between the exploration tool and a recording unit arranged overground, where at least one of the transmitter or receiver is integrated in the exploration tool.

The exploration tool is a device which is able to penetrate into the underground in order to bring equipment into the underground independent of any existing or new wells. The exploration tool is not necessarily a well drilling tool. The exploration tool may be a stand-alone unit, for example a vehicle which is able to bring a probe into the underground.

The exploration tool is adapted to penetrate into the underground for example by having drilling equipment. The drilling equipment may be incorporated/built-in in the exploration tool. The exploration tool may in one embodiment be of the kind described in international patent publication WO 02/14644, the content of which is hereby incorporated by reference. In another embodiment, the exploration tool may be a wire line drilling tool.

The exploration tool is communicating with the surface/topside/overground, for example by means of cables or by other suitable means. The exploration tool may be powered from surface through the same or a different cable, or may be self-powered.

The exploration tool comprises in one embodiment guiding means and is adapted to be guided to a specific location underground. In this way the user has full control of the location of the exploration tool, which may be very useful when the system is used for mapping hydrocarbon resources. The guiding means may be controlled by an operator wirelessly or by wire or the guiding means may be pre-programmed to direct the exploration tool to the desired location. The exploration tool may be adapted to move in any direction underground, in particular vertical downwards, horizontal and angles between these two directions.

The transmitter will send out a wave which will be attenuated during propagation. The attenuation will differ according to the characteristics of the area through which the wave is propagating. The receiver will detect the incoming wave and the attenuation is used to calculate the characteristics of the underground in this area, including the presence and distance to structures of interest. A number of such calculations may be used to build a tomographic picture.

When the location of the transmitter and receivers are known, the location data can be used for calculation of the location of identified structures of interest. Also the exploration tool(s) may be guided to a location of particular interest in order to fill in an existing map of the area or in order to confirm or contradict an anticipated structure of interest.

In the examples of this description, the at least one transmitters and receivers are electromagnetic transmitters and receivers. The principle may, however, also be embodied with seismic source(s) and seismic receiver(s).

There may also be a combination of seismic and electromagnetic transmitters and receivers.

In one embodiment, one or more receivers and/or transmitters may be located overground/at the surface.

The number of exploration tools can be chosen according to the need for accuracy of the exploration and/or depending of the area to be explored. A higher number of exploration tools will lead to more information and thus a more detailed exploration of the area of interest.

When the system comprises more that one exploration tool, the exploration tools may be located on the same or different depths. The exploration tools may also sequentially be moved to new positions and thus map the area in greater detail.

Locating a number of exploration tools at different geographical positions as well as different depths opens for more information which may be used to calculate the location of the structures of interest.

In one embodiment, the system comprises at least two exploration tools where at least one exploration tool has integrated transmitter and at least one exploration tool has integrated receiver.

The exploration tool may have integrated both transmitter and receiver or a combined transmitter/receiver. In one embodiment, the transmitter and receiver of the exploration tool are operated sequentially, the exploration tool thus functioning alternating as a transmitter and receiver. Having a number of exploration tools where each comprises both transmitter and receiver will lead to increased amount of information.

In one embodiment the exploration tool is an electromagnetic exploration tool and comprises a longitudinal body having a potential difference between the two opposite ends. Between the ends, the longitudinal body may be electrically insulated. The tool thus forms an electrical dipole which can transmit electromagnetic signals into the formation.

The same embodiment can also function as a receiver of electromagnetic signals by measuring the voltage signals received by the dipole. Introducing a set of such tools with communication to topside, opens for wave measurements through the reservoir from many directions and accurate inversion calculations in order to characterise the formation and how it changes over time. Thus the movement of water and gas fronts may be accurately detected.

The invention will now be described in more detail by means of examples and the accompanying figures.

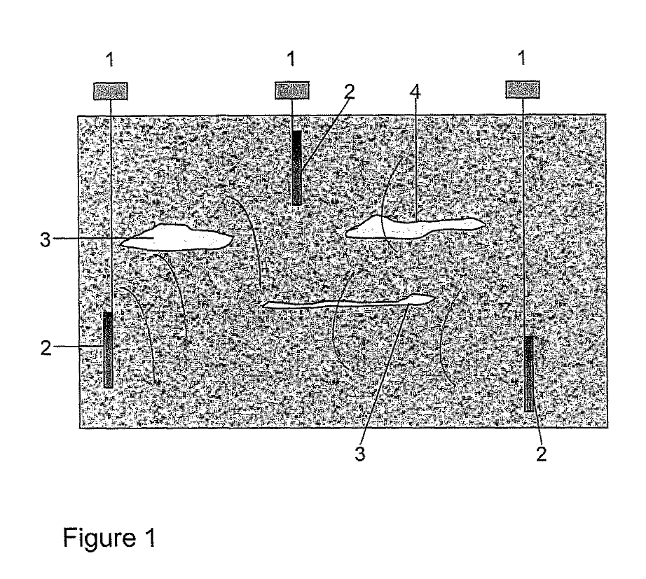

FIG. 1 shows an example embodiment of the invention.

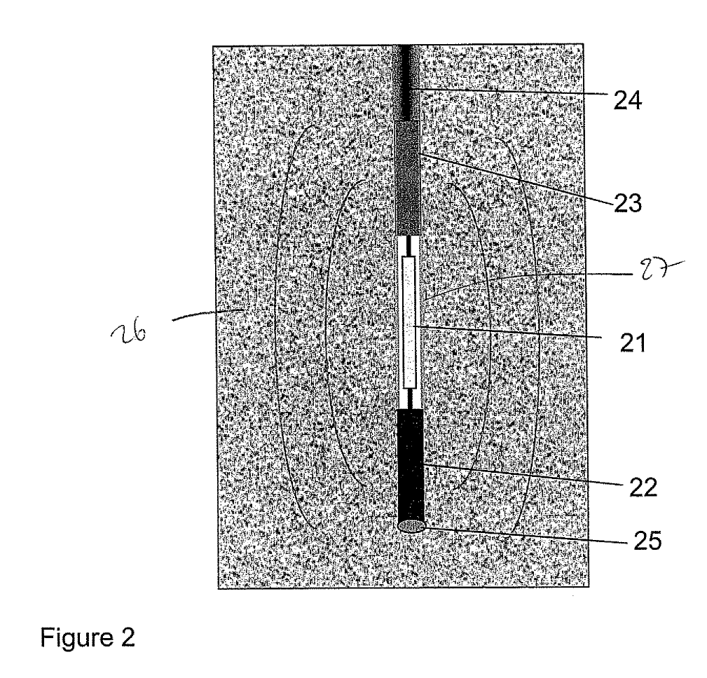

FIG. 2 shows an example of an exploration tool for use in the system according to the invention.

In the system of FIG. 1, three exploration tools 2 have penetrated into the underground and are located in the underground. The underground comprises water saturated areas 3 and oil/gas filled areas 4. The three exploration tools have penetrated into the ground and are located on different depths and spread over an underground area. The exploration tools are each connected to a respective recording unit 1 arranged overground/topside which receive data from the individual exploration tools 2. In one embodiment, the exploration tools may be connected to the same recording unit 1. The exploration tools are in this embodiment sequentially sending and receiving electromagnetic signals, ie. are sequentially/alternating working as receivers and transmitters, and transmitting signals to the recording units topside. In alternative embodiments, the exploration tools may work only as receivers or transmitters respectively, sending and receiving to other exploration tools underground. Transmitters and/or receivers may also be located overground/at the surface, for example receivers underground receiving signals from transmitters overground, receivers overground receiving signals from transmitters underground, or combinations of these.

The water saturated areas 3 will have low resistivity and high damping of the electromagnetic waves, while the oil filled (or gas filled) areas have high resistivity and offer little attenuation of the electromagnetic waves. In this way the signals transmitted to the recording units have different characteristics depending on the underground structures they have penetrated or if they have been reflected, and this may be used to provide a mapping/picture of the area underground in order to characterize it and possibly discover and identify sources/reservoirs of oil and/or gas.

The exploration tools 2 may be left in their position and can be used to continuously monitor the area in order to detect changes in known reservoirs and/or watch movements of gas or fluids in known reservoirs. Alternatively, the exploration tools 2 may be instructed to move to another location in order to survey another area, or in order to provide information from a larger area.

The same configuration of exploration tools may be used for seismic exploration, the transmitters and receivers being seismic transmitters and receivers, or there may be a combination of seismic and electromagnetic transmitters and receivers.

In FIG. 2 is shown an example of an electromagnetic exploration tool, for example used in the system of FIG. 1. The middle portion 27 of the tool is electrically insulated from the formation 26 and a ac voltage is set up between the two ends 22 and 23 by means of a voltage generator connected to the two ends, the tool thus constituting a dipole. In one embodiment the two ends are electrically insulated from each other in order to prevent the current from shorting through salt water in the annulus, but propagate into the formation. The voltage generator may for example be arranged in a transceiver 21. Then voltage generator may in one embodiment be embodied as an inverter directly fed from the primary inverter of the tool. The voltage between the two ends will set up an electromagnetic near field around the dipole which will propagate outwards from the dipole, the tool thus working as a transmitter. The same tool may also be used as a receiver, registering an incoming electromagnetic field reflected from or having propagated through a formation.

The tool is powered and communicates to topside through a cable 24.

A drill bit 25 may be provided at the bottom end in order to enable the tool to penetrate the underground.

The tool may for example be built into a tool as described in patents NO3113110/U.S. Pat. No. 7,093,673.

1. A system for exploration of subterranean structures comprising:
at least one exploration tool adapted to penetrate into the underground independent of a well,
at least one transmitter sending a signal wave into an underground area,
at least one receiver receiving the signal wave from the underground area, and
signal transfer means for transmitting signals between the exploration tool and a recording unit arranged overground,
where at least one of the transmitters or receivers are integrated in the exploration tool.

2. The system according to claim 1, wherein the exploration tool comprises guiding means and is adapted to be guided to a specific location underground.

3. The system according to claim 2, wherein the system comprises at least two exploration tools where at least one exploration tool has an integrated transmitter and at least one exploration tool has an integrated receiver.

4. The system according to claim 3, wherein the system
comprises at least two exploration tools located on the same or different depths over an underground area, each of the exploration tools having integrated
electromagnetic transmitters and/or receivers, and the signals received by the receivers are used to calculate the characteristics of the underground area.

5. The system according to claim 1, wherein at least one of the transmitters and receivers are electromagnetic transmitters and receivers.

6. The system according to claim 1, wherein at least one of the transmitters and receivers is a seismic source and a seismic receiver.

7. The system according to claim 1, wherein two or more exploration tools are located at different depths.

8. The system according to claim 1, wherein the exploration tool comprises a longitudinal body having a potential difference between the two opposite ends.

9. The system according to claim 5, wherein the longitudinal body is electrically insulated between the two opposite ends.

10. The system according to claim 1, wherein at least one receiver is arranged overground.

11. The system according to claim 1, wherein at least one transmitter is arranged overground.

12. The system according to claim 1, wherein the exploration tool is arranged to continue penetration and can sequentially be operated in several different positions.

13. The system according to claim 2, wherein the system comprises at least two exploration tools where at least one exploration tool has an integrated transmitter and at least one exploration tool has an integrated receiver.

14. The system according to claim 13, wherein the system comprises
at least two exploration tools located on the same or different depths over an underground area, each of the exploration tools having integrated
electromagnetic transmitters and/or receivers, and the signals received by the receivers are used to calculate the characteristics of the underground area.
